(19) United States
(12) Patent Application Publication
(10) Pub. No.: US 2022/0114508 A1
(43) Pub. Date: Apr. 14, 2022

(54) ENRICHING PROCESS MODELS FROM UNSTRUCTURED DATA AND IDENTIFY INEFFICIENCIES IN ENRICHED PROCESS MODELS

(71) Applicant: INTERNATIONAL BUSINESS MACHINES CORPORATION, Armonk, NY (US)

(72) Inventors: Jayachandu Bandlamudi, Guntur (IN); Prerna Agarwal, New Delhi (IN); Sampath Dechu, Bangalore (IN)

(21) Appl. No.: 16/949,017

(22) Filed: Oct. 9, 2020

(51) Int. Cl. G06Q 10/06

(52) U.S. Cl. CPC G06Q 10/067; G06Q 10/06375; G06Q 10/06393

(57) ABSTRACT

A method, computer system, and a computer program product for process optimization is provided. The present invention may include analyzing a business process model comprised of one or more activities. The present invention may include extracting one or more key phrases from one or more event logs, wherein the one or more event logs are based on the business process model. The present invention may include determining a corresponding activity for the one or more extracted key phrases. The present invention may include generating an enriched business process model based on the business process model and one or more derived activities.

### BACKGROUND

The present invention relates generally to the field of computing, and more particularly to business processes.

A business process may be defined as a collection of related, structured activities or tasks that produce a specific service or product for a particular customer or customers. A business process model may be in the form of a Directly-Follows graph. Directly-Follows graphs may utilize nodes to represent activities and may utilize directed edges between nodes to represent different metrics.

Companies may adopt different forms of business process management in order to adapt and continuously improve business processes to stay competitive.

### SUMMARY

Embodiments of the present invention disclose a method, computer system, and a computer program product for process optimization. The present invention may include analyzing a business process model comprised of one or more activities. The present invention may include extracting one or more key phrases from one or more event logs, wherein the one or more event logs are based on the business process model. The present invention may include determining a corresponding activity for the one or more extracted key phrases. The present invention may include generating an enriched business process model based on the business process model and one or more derived activities.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for process optimization according to at least one embodiment;

FIG. 3 is an exemplary illustration of a business process model in the form of a Directly-Follows graph with frequency Key Performance Indicators according to at least one embodiment;

FIG. 4 is a block diagram of internal and external components of computers and servers depicted in FIG. 1 according to at least one embodiment;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for process optimization. As such, the present embodiment has the capacity to improve the technical field of business processes by enriching a business process model using unstructured data and identifying inefficiencies and bottlenecks within an enriched business process model. More specifically, the present invention may include analyzing a business process model comprised of one or more activities. The present invention may include extracting one or more key phrases from one or more event logs, wherein the one or more event logs are based on the business process model. The present invention may include determining a corresponding activity for the one or more extracted key phrases. The present invention may include generating an enriched business process model based on the business process model and one or more derived activities.

As described previously, a business process may be defined as a collection of related, structured activities or tasks that produce a specific service or product for a particular customer or customers. A business process model may be in the form of a Directly-Follows graph. Directly-Follows graphs may utilize nodes to represent activities and may utilize directed edges between nodes to represent different metrics.

Companies may adopt different forms of business process management in order to adapt and continuously improve processes to stay competitive.

Therefore, it may be advantageous to, among other things, analyze a business process model comprised of one or more activities. Extract one or more key phrases from one or more event logs, wherein the one or more event logs are based on the business process model. Determine a corresponding activity for the one or more extracted key phrases. Generate an enriched business process model based on the business process model and one or more derived activities.

The present invention may improve business process models by extracting one or more key phrases from one or more event logs, determining a corresponding activity for the one or more extracted key phrases, and generating an enriched business process model based on the business process model and one or more derived activities.

The present invention may improve business process models by extracting one or more key phrases from unstructured data of the one or more event logs.

The present invention may improve business process models by determining one or more key performance indicators for the one or more activities of the enriched business process model.

The present invention may improve business process models by utilizing the one or more key performance indicators to determine a hot spot index score of each of the one or more activities of the enriched business process model and recommending one or more interventions based on the hotspot index score.

According to at least one embodiment the key performance indicators may include, but are not limited to including, time duration, frequency, actor inefficiency, and centrality of the activity. The one or more key performance indicators may be helpful in identifying inefficiencies and bottlenecks within a business process model.

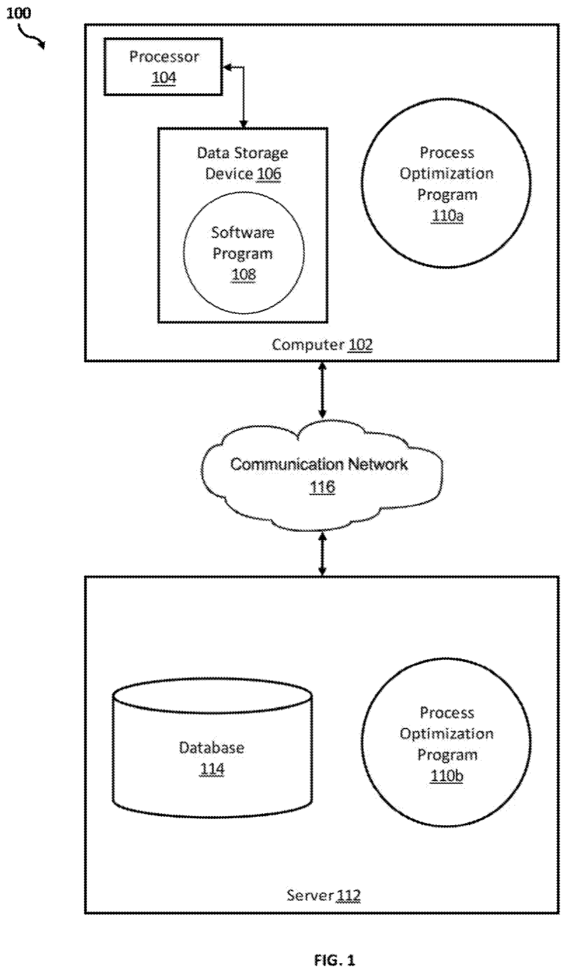

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a process optimization program 110a. The networked computer environment 100 may also include a server 112 that is enabled to run a process optimization program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

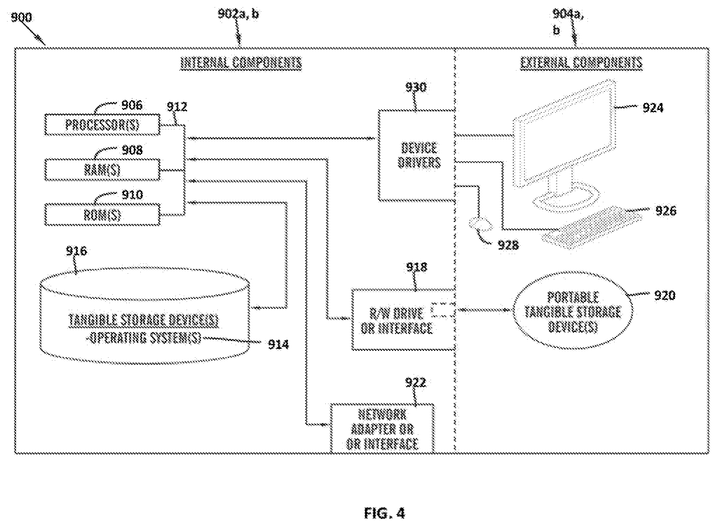

The client computer 102 may communicate with the server computer 112 via the communications network 116. The communications network 116 may include connections, such as wire, wireless communication links, or fiber optic cables. As will be discussed with reference to FIG. 4, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the process optimization program 110a, 110b may interact with a database 114 that may be embedded in various storage devices, such as, but not limited to a computer/mobile device 102, a networked server 112, or a cloud storage service.

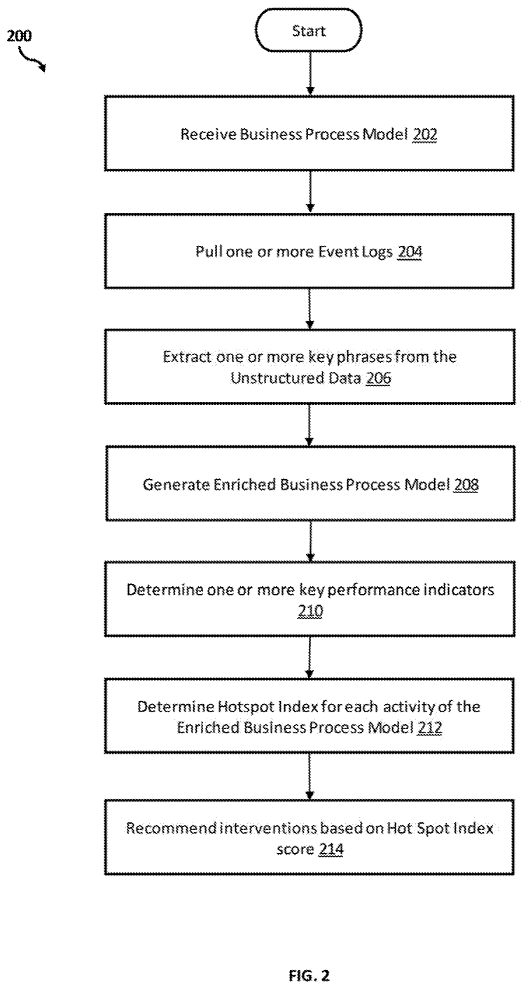

According to the present embodiment, a user using a client computer 102 or a server computer 112 may use the process optimization program 110a, 110b (respectively) to analyze a business process model, extract one or more key phrases from one or more event logs, determine a corresponding activity for the one or more key phrases, and generate an enriched business process model. The process optimization method is explained in more detail below with respect to FIG. 2.

Referring now to FIG. 2, an operational flowchart illustrating the exemplary process optimization process 200 used by the process optimization program 110a and 110b (hereinafter referred to as process optimization program 110) according to at least one embodiment is depicted.

At 202, a selected business process model is received by the process optimization program 110. The business process model (BPM) may be selected by the process optimization program 110. The business process model (BPM) may be selected by a user. The BPM may be in the form of a Directly-Follows graph.

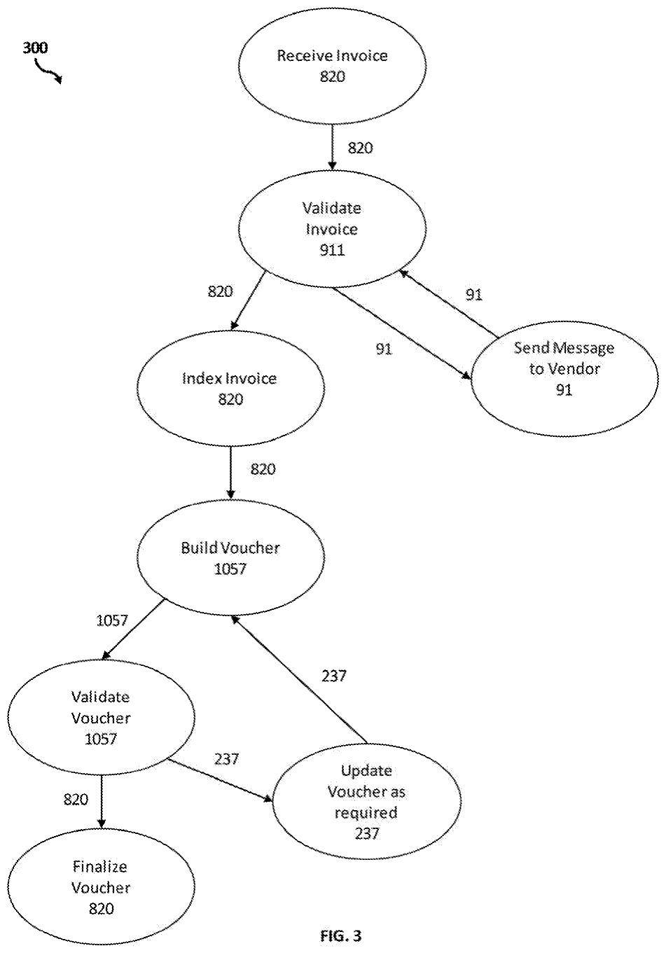

Directly-Follows graphs may be graphs where nodes may represent the activities in the log and directed edges may be present between the nodes. The directed edges may be present between the nodes as a trace where the source activity may be followed by a target activity. The directed edges may enable the representation of metrics like frequency (e.g., the number of times an activity has occurred, amount of times a node is interacted with in the BPM Directly-Follows graph) and time duration (e.g., activity performance time, such as the time inter-lapsed between two activities). This will be explained in more detail with respect to FIG. 3 below.

Accordingly, the BPM may be comprised of one or more activities (e.g., nodes). A user may frequently execute a BPM. The same or similar BPM may vary in execution time (e.g., time to complete the entire BPM). The execution time of the BPM may vary due to varying time durations of the one or more activities. The amount of time to complete the same activity may vary in different executions of the same or similar BPMs. The amount of time to complete the same activity may vary due to inefficiencies in the BPM.

The one or more activities may transition from the source activity to a target activity. The amount of time for the transition from the source activity to the target activity may vary. The amount of time for the transition may be determined based on the time inter-lapsed between two activities.

For example, a BPM for invoice processing may be executed multiple times a day by a business. Although the BPM for invoice processing may remain constant, the trace (e.g., time taken to execute the BPM) may vary.

At 204, the process optimization program 110 may pull one or more event logs. The process optimization program 110 may pull one or more event logs based on the BPM selected. The one or more event logs may be comprised of unstructured data and structured data relating to the BPM.

The structured data of the one or more event logs may include, but is not limited to including, time stamps, actor, dates, phone numbers, social security numbers, credit card numbers, customer names, addresses, product names, product numbers, and transactional information.

The unstructured data of the one or more event logs may include, but is not limited to including, comments made by an actor (e.g., person performing an activity within the BPM, person filling out an event log), text files, reports, email messages, audio files, video files, images.

The process optimization program 110 may utilize the structured data of the one or more event logs to determine a corresponding activity for the unstructured data.

For example, the process optimization program 110 may utilize structured data such as, but not limited to, time stamps and identity of an actor (e.g., person performing an activity within the BPM, person filling out an event log), to determine that the unstructured data (e.g., the comments by the actor) correspond to the activity of validating a voucher for the selected BPM (e.g., an Invoice Processing BPM).

At 206, the process optimization program 110 extracts one or more key phrases from the unstructured data. The one or more key phrases from the unstructured data may have a corresponding activity. The corresponding activity may be an existing activity.

The process optimization program 110 may determine one or more derived activities within the corresponding activity based on the one or more key phrases. The one or more derived activities may be multiple activities performed within a single node (e.g., a node of the Directly-Follows graph). The single node may represent an activity of the BPM.

For example, within an Invoice Processing BPM an activity (e.g., node) may be Build a Voucher. For an existing client or a recurring order, the Build a Voucher activity may be completed relatively quickly by an actor (e.g., employee performing an activity with the BPM). However, for a new client or a foreign client the Build a Voucher activity may take significantly more time to be completed by an actor. As opposed to identifying a bottleneck (e.g., an inefficient activity in the BPM) the data optimization program 110 may utilize the unstructured data corresponding to the Build a Voucher activity to determine one or more derived activities.

At 208, the process optimization program 110 generated an enriched business process model. The enriched business process model may be comprised of the one or more activities of the BPM, as well the one or more derived activities determined by the process optimization program 110 from the unstructured data of the one or more event logs.

The process optimization program 110 may add the one or more derived activities to the BPM to generate the enriched business process model. The one or more derived activities may be determined from the one or more key phrases extracted from the unstructured data. The one or more derived activities may be added to the BPM trace that connects existing activities to generate the enriched business process model. The enriched business process model may be utilized to compute inefficiencies.

The process optimization program 110 may update the event log with the derived activities for future use. The process optimization program 110 may create a new field within the one or more event logs. The process optimization program 110 may assign the one or more derived activities to the new field of the one or more event logs.

At 210, the process optimization program 110 determines one or more key performance indicators (KPIs) for the one or more activities of the enriched business process model. The one or more key performance indicators may include, but are not limited to including, time duration, frequency, actor inefficiency, and centrality of the activity. This will be explained in more detail with respect to FIG. 3 below.

A key performance indicator for time duration may be calculated using the following equation:

$$T ( A ) = ( \frac{{t}_{activity} + {t}_{transition}}{{t}_{trace}} )$$

in which t_{activity} may be a time duration of activity A, tₜᵣₐₙₛᵢₜᵢₒₙ may be a total time duration transitioning in and out from activity A in a trace, and t_{trace} may be a total time duration of a trace (e.g., time to complete the entire enriched business process model). The key performance indicator for time duration equation may provide a value (e.g., percentage, fraction) that may indicate the relative time spent on a given activity in relation to the trace of the enriched business process.

The key performance indicator for time duration (e.g., activity performance time) may be determined for each activity (e.g., node) of the enriched business process model. A higher time duration value may indicate that a major portion of the overall time spent executing the enriched business process model.

For example, if activity A has a time duration value of ¼ and activity B has a time duration value of ½, this may indicate that twice as much time was spent performing activity B as compared to activity A.

A key performance indicator for frequency may be calculated using the following equation:

$$F ( A ) = ( \frac{{f}_{activity}}{{f}_{max}} )$$

in which f_{activity} may be a number of traces passing through an activity A, and fₘₐₓ may represent a maximum frequency in which a number of traces pass through any activity of the enriched business model.

The key performance indicator for frequency may be determined for each activity (e.g., node) of the enriched business process model. A higher frequency value (e.g., value approaching or equal to 1) may indicate that even if an activity is efficient (e.g., low inefficiency) the overall impact on the enriched business process model may be great because of the number of times the trace passes through the activity.

A key performance indicator for actor inefficiency may be calculated using the following equation:

$$AI ( X / A ) = ( \frac{{t}_{actor}}{{t}_{max activity}} ) * ( \frac{{f}_{actor}}{{f}_{activity}} )$$

in which t_{actor} may represent the total time taken by actor (X) to perform activity A, t_{maxactivity} may represent the maximum of total time taken by actors to perform activity A, f_{actor} may represent the number of times actor (X) performs activity A, and f_{activity} may represent the number of times activity A occurs.

The key performance indicator for actor inefficiency may be determined for each activity in which an actor performs the activity. The key performance indicator for actor inefficiency may indicate the time taken by an actor to perform the activity with respect to the time taken by other actors to perform that activity.

A key performance indicator for activity centrality may be calculated using the following equation:

$$A C ( A ) = \frac{n - 1}{{\sum }_{a ∈ V}^{d ( a , A )}}$$

in which n may represent the number of activities that activity A is connected to, Σ may represent may represent the summation of minimum hop distance (e.g., distance between activities on the Directly-Follows graph of the enriched business process method) between activity A and each of V, V may represent the set of activities that activity A is connected to, a may represent one value of V at a time, € may represent that a can take one value at a time from a set V, d may represent the minimum hop distances (e.g., distance between activities on the Directly-Follows graph of the enriched business process method) between two activities.

The key performance indicator for activity centrality may be determined for each activity (e.g., node) of the enriched business process model. The higher the value of the activity centrality for an activity (e.g., node) the larger the impact of the activity (e.g., node) on the enriched business process method.

For example, if activity A is connected to activity C, activity D, and activity E, the value of n may be 3. V may equal (C, D, E), Σ may represent the summation of minimum hop distance between activity A and each of activities (C, D, E). Since a may represent one value from the set of activities V at a time, here, it could be C, D, or E. € may represent that a may take one value at a time from set V. Finally, d may represent the minimum hop distance between A and a connected activity, here, we would compute d(A,C), d(A,D), and d(A,E).

At 212, the process optimization program 110 utilizes the one or more key performance indicators to determine a hotspot index score for each activity of the enriched business model.

The process optimization program 110 may utilize the following equation:

HI(A)=T(A)*F(A)*max(AI(X,A))*AC(A)

to calculate the hotspot index score for each activity, in this equation A represents activity A. T(A) may represent the time duration of activity A, F(A) may represent the frequency of activity A, max AI(X,A) may represent highest inefficiency of an actor X performing activity A, and AC(A) may represent the activity centrality of activity A.

The process optimization program 110 may rank the one or more hotspot index scores of the one or more activities of the enriched business process model. The process optimization program 110 may rank the activities from largest to smallest hotspot index score. A larger the hotspot index score for an activity may indicate a higher inefficiency (e.g., less efficient) activity.

At 214, the process optimization program 110 recommends one or more interventions. The process optimization program 110 may recommend one or more interventions based on one or more key performance indicators. The process optimization program 110 may utilize the hotspot index score to identify combinations of key performance indicators contributing to inefficiencies or bottlenecks in the enriched business process model.

Combinations of key performance indicators may have a confounding effect on the enriched business process model. The process optimization program 110 may utilize the hotspot index score to identify one or more key performance indicators with the confounding effect on the enriched business process model and recommend one or more interventions to limit the confounding effect.

The process optimization program 110 may perform an impact assessment of the one or more recommended interventions. The process optimization program 110 may provide one or more Directly-Follows graphs based on the one or more recommended interventions.

For example, the process optimization program 110 may recommend a specific actor for an activity based on the activity centrality. The process optimization program 110 may perform an impact assessment of this intervention and determine an amount of time that may be saved based on the recommended intervention.

Referring now to FIG. 3, is an exemplary illustration of a business process model in the form of a Directly-Follows graph with frequency Key Performance Indicators according to at least one embodiment.

The business process model Directly-Follows graph depicted illustrates the frequency Key Performance Indicators for an Invoice Processing business process model. In the Invoice Processing business process model depicted the arrows represent the directed edges between the nodes (e.g., activities) and the values next to the arrows represent the frequency metric.

In the Directly-Follows graph depicted the activity (e.g., node) Receive Invoice has a frequency (e.g., number of times an activity has occurred, amount of times a node is interacted with in the BPM Directly-Follows graph) of 820, Validate Invoice has a frequency of 911, Send Message to Vendor has a frequency of 91, Index Invoice has a frequency of 820, Build Voucher has a frequency of 1057, Validate Voucher has a frequency of 1057, Update Voucher as required has a frequency of 237, and Finalize Voucher has a frequency of 820.

The data optimization program 110 may determine the frequency for each activity (e.g., node) using the following equation:

$$F ( A ) = ( \frac{{f}_{activity}}{{f}_{max}} )$$

in which f_{activity} may be a number of traces passing through an activity A, and fₘₐₓ may represent a maximum frequency in which a number of traces pass through any activity of the enriched business model.

For example, in the Invoice Processing business process model depicted the frequency for Send Message to Vendor would be calculated as follows:

$$F ( Send Message to Vendor ) = ( \frac{91}{1057} ) \qquad$$

Since, 91 is the number of traces passing through the Send Message to Vendor activity (e.g., node), and 1057 represents the maximum frequency in which a number of traces passes through any activity (e.g., node), both Validate Voucher and Build Voucher. Accordingly, the frequency Key Performance Indicator value for Send Message to Vendor would be

$$\frac{91}{1057}$$

or 8.6 percent.

It may be appreciated that FIGS. 2 and 3 provide only an illustration of one embodiment and do not imply any limitations with regard to how different embodiments may be implemented. Many modifications to the depicted embodiment(s) may be made based on design and implementation requirements.

FIG. 4 is a block diagram 900 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 4. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the process optimization program 110a in client computer 102, and the process optimization program 110b in network server 112, may be stored on one or more computer-readable tangible storage devices 916 for execution by one or more processors 906 via one or more RAMs 908 (which typically include cache memory). In the embodiment illustrated in FIG. 4, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the process optimization program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the process optimization program 110a in client computer 102 and the process optimization program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the process optimization program 110a in client computer 102 and the process optimization program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

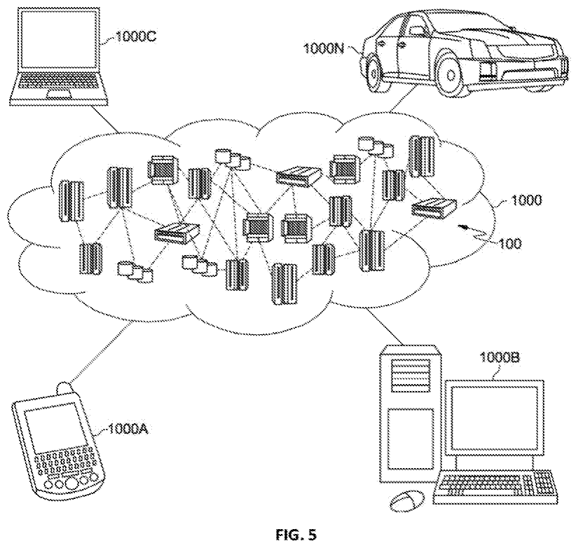

Referring now to FIG. 5, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 5 are intended to be illustrative only and that computing nodes 100 and cloud computing environment 1000 can communicate with any type of computerized device over any type of network and/or network addressable connection (e.g., using a web browser).

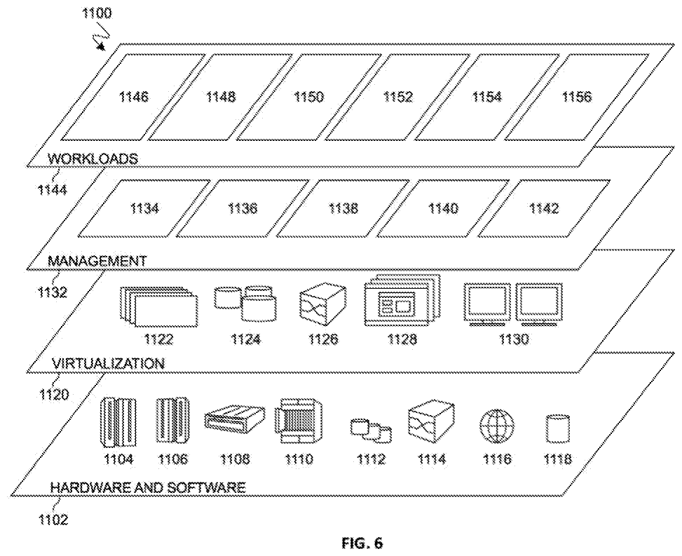

Referring now to FIG. 6, a set of functional abstraction layers 1100 provided by cloud computing environment 1000 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and process optimization 1156. A process optimization program 110a, 110b provides a way to analyze a business process model, extract one or more key phrases from one or more event logs, determine a corresponding activity for the one or more key phrases, and generate an enriched business process model.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for process optimization, the method comprising:
analyzing a business process model comprised of one or more activities;
extracting one or more key phrases from one or more event logs, wherein the one or more event logs are based on the business process model;
determining a corresponding activity for the one or more extracted key phrases; and
generating an enriched business process model based on the business process model and one or more derived activities.

2. The method of claim 1, wherein the one or more key phrases are extracted from unstructured data of the one or more event logs.

3. The method of claim 1, wherein determining the corresponding activity for the one or more key phrases is based on structured data of the one or more event logs.

4. The method of claim 1, further comprising:
determining one or more key performance indicators for each activity of the enriched business process model; and
utilizing the one or more key performance indicators to determine a hotspot index score of each of the one or more activities of the enriched business process model.

5. The method of claim 4, further comprising:
ranking the hotspot index score for each of the one or more activities of the enriched business process model, wherein the hotspot index score is ranked based on inefficiency.

6. The method of claim 4, further comprising:
recommending one or more interventions based on the hotspot index score; and
performing an impact assessment based on the one or more interventions.

7. The method of claim 4, further comprising:
recommending one or more interventions based on the hotspot index score; and
providing a Directly-Follows graph based on the one or more recommended interventions.

8. A computer system for process optimization, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing a business process model comprised of one or more activities;
extracting one or more key phrases from one or more event logs, wherein the one or more event logs are based on the business process model;
determining a corresponding activity for the one or more extracted key phrases; and
generating an enriched business process model based on the business process model and one or more derived activities.

9. The computer system of claim 8, wherein the wherein the one or more key phrases are extracted from unstructured data of the one or more event logs.

10. The computer system of claim 8, wherein determining the corresponding activity for the one or more key phrases is based on structured data of the one or more event logs.

11. The computer system of claim 8, further comprising:
determining one or more key performance indicators for each activity of the enriched business process model; and
utilizing the one or more key performance indicators to determine a hotspot index score of each of the one or more activities of the enriched business process model.

12. The computer system of claim 11, further comprising:
ranking the hotspot index score for each of the one or more derived activities of the enriched business process model, wherein the hotspot index score is ranked based on inefficiency.

13. The computer system of claim 11, further comprising:
recommending one or more interventions based on the hotspot index score; and
performing an impact assessment based on the one or more interventions.

14. The computer system of claim 11, further comprising:
recommending one or more interventions based on the hotspot index score; and
providing a Directly-Follows graph based on the one or more recommended interventions.

15. A computer program product for process optimization, comprising:
one or more non-transitory computer-readable storage media and program instructions stored on at least one of the one or more tangible storage media, the program instructions executable by a processor to cause the processor to perform a method comprising:
analyzing a business process model comprised of one or more activities;
extracting one or more key phrases from one or more event logs, wherein the one or more event logs are based on the business process model;
determining a corresponding activity for the one or more extracted key phrases; and
generating an enriched business process model based on the business process model and one or more derived activities.

16. The computer program product of claim 15, wherein the one or more key phrases are extracted from unstructured data of the one or more event logs.

17. The computer program product of claim 15, wherein determining the corresponding activity for the one or more key phrases is based on structured data of the one or more event logs.

18. The computer program product of claim 15, further comprising:
determining one or more key performance indicators for each activity of the enriched business process model; and
utilizing the one or more key performance indicators to determine a hotspot index score of each of the one or more activities of the enriched business process model.

19. The computer program product of claim 18, further comprising:
ranking the hotspot index score for each of the one or more derived activities of the enriched business process model, wherein the hotspot index score is ranked based on inefficiency.

20. The computer program product of claim 18, further comprising:
recommending one or more interventions based on the hotspot index score; and
performing an impact assessment based on the one or more interventions.
